(19) United States
(12) Patent Application Publication
(10) Pub. No.: US 2002/0107053 A1
(43) Pub. Date: Aug. 8, 2002

(54) PTT speaker/mike assembly

(76) Inventors: Jose A. Petez, Irwindale, CA (US); Ruben Scheimberg, Santa Clarita, CA (US)

Correspondence Address: LEON D. ROSEN, FREILICH, HORNBAKER & ROSEN, Suite 1220, 10960 Wilshire Blvd., Los Angeles, CA, 90024, US

(21) Appl. No.: 09/927,147

(22) Filed: Aug. 10, 2001

Related U.S. Application Data
(60) Provisional application No. 60/266,250, filed on Feb. 5, 2001.

(51) Int. Cl. H04M 1/00

(52) U.S. Cl. 455/569; 455/568

(57) ABSTRACT

A PTT transceiver (10) includes a mount assembly (16) comprising a shell (30) and a speaker/mike assembly (14) that includes a speaker (20) in the shell and a microphone (22) that lies in the same shell. The shell has a proximal end (66) with at least one opening (70) through which sound can pass out from the speaker and sound can pass to the microphone. An ear mount (32) holds the proximal end of the shell immediately outside an ear canal (C) of a person in an ear entrance region (80), it being found that sound from a person speaking can be detected near the outer end of the ear canal.

### CROSS-REFERENCE TO RELATED APPLICATION

Applicant claims priority from U.S. provisional patent application Ser. No. 60/266,250 filed Feb. 5, 2001.

### BACKGROUND OF THE INVENTION

Many specialized communication systems, or networks, use PTT (push to talk) speaker and microphone combinations. For example, a group of firemen may each have a two-way radio with a speaker and microphone, where the speakers are on almost all the time when battling a fire, so each fireman can hear any message transmitted by any other fireman in the group. However, each fireman's microphone is on only during the time when the fireman keeps a PTT switch closed by continuing to apply pressure to it. A fireman will depress the PTT switch and speak, only when he has something important to say.

One type of speaker/microphone combination includes a speaker on a transceiver that may be worn on the fireman's belt, and a microphone and PTT switch that lie at the end of a coiled cable. When the fireman wishes to speak, he grasps the combination microphone and PTT switch and moves it up to his mouth and keeps the PTT switch depressed while talking, to transmit a voice message. Another type of combination includes a headset that is worn by the fireman, dispatcher or other person, which includes a microphone at the end of a curved tube, with the microphone lying perhaps one inch forward of the speaker's mouth. Switching is accomplished by depressing a switch with the hand or another part of the body. The long tube in front of the person's face makes this device cumbersome. A very compact and comfortable speaker/mike combination for a PTT system, would be of value.

### SUMMARY OF THE INVENTION

In accordance with one embodiment of the present invention, a speaker and microphone assembly for a PTT transceiver, is provided which is of small size and which can be worn as a unit comfortably adjacent to an ear of the person. The microphone lies closely outside the ear canal of the person and the speaker lies adjacent to the microphone. The microphone lies in the stream of sound that passes from the speaker to the person's ear canal, so if the speaker and microphone happened to be on at the same time there would be a feedback loop. Of course, in a PTT system, either the speaker or microphone is on at any given time, but not both. A mount assembly holds the speaker and microphone outside but adjacent to one of the person's ear canals.

The mount assembly includes a shell having a proximal end closest to the ear canal, and with at least one opening in the proximal end. Both the speaker and microphone lie within the shell. The speaker is generally of larger diameter than the microphone, and the microphone lies between the speaker and the opening but has a smaller diameter than the speaker to block only a minimum of sound. The mount assembly also includes a bar with a concave side that fits around the back of a person's ear and that extends largely vertically from the top or bottom of the ear and that holds the shell at the middle of the ear and preferably partially inside an entrance that leads to the ear canal.

The microphone and proximal end of the shell lie in a sound pickup region that applicant has found to exist immediately outside a person's ear canal, where sounds from a person speaking can be picked up. The microphone and at least one opening of the shell lie within a pickup region of a cylindrical shape with an axis, with the radius of the cylinder being three-quarters inch and the length being one and one-half inches. The shell proximal end preferably lies within an ear entrance region that extends about 0.75 inch outward from the outer end of the ear canal.

The novel features of the invention are set forth with particularity in the appended claims. The invention will be best understood from the following description when read in conjunction with the accompanying drawings.

### BRIEF DESCRIPTION OF THE DRAWINGS

FIG. 1 is a side elevation view of a speaker/microphone assembly of a PTT transceiver, showing it lying outside an ear of a person.

FIG. 2 is a sectional view taken on line 2-2 of FIG. 1, and showing in simplified form, circuitry of the PTT transceiver.

FIG. 3 is a front isometric view of the speaker/microphone assembly of FIG. 1.

### DESCRIPTION OF THE PREFERRED EMBODIMENTS

FIG. 1 illustrates a portion of PTT transceiver 10 which includes a combination 12 of a speaker and microphone assembly 14 and a mount assembly 16 that supports the speaker and microphone assembly immediately outside one ear E of a person. The speaker/mike assembly 14 includes a speaker 20 for generating sound to be heard by the person, and a microphone 22 for detecting the voice of the person when he/she speaks (which includes any sound made by a person). The mount assembly 16 includes a shell 30 that encloses the speaker and microphone and a mount 32 that mounts on the ear of the person. The transceiver also includes a two-way radio 40 with a manually-operated (operated by moving a part of the body or by voice) PTT switch 42. When the PTT switch is operated, the speaker 20 is not energized and sounds picked up the microphone 22 are broadcast to other transceivers in a defined group of transceivers. However, when the switch 42 is not operated, any sound at the microphone 22 will not be transmitted over radio waves, but the speaker 20 will generate sounds representing radio waves that have been detected by the two-way radio.

The mount 32 includes a bar 50 with a concave side 52 that lie around the rear of the ear and adjacent to a side of the person's head. The mount also includes a rod 54 that extends vertically, preferably from the top of the bar 50, and which holds the shell 30 which contains the speaker and microphone, at the ear of the person. The rod 54 can be moved slightly up or down to accurately position the shell. The microphone and speaker are connected by a cord 61 with a plurality of electrical conductors, with two pairs of conductors 62, 64 being indicated, that extend to a plug 66 that is plugged into the two-way radio.

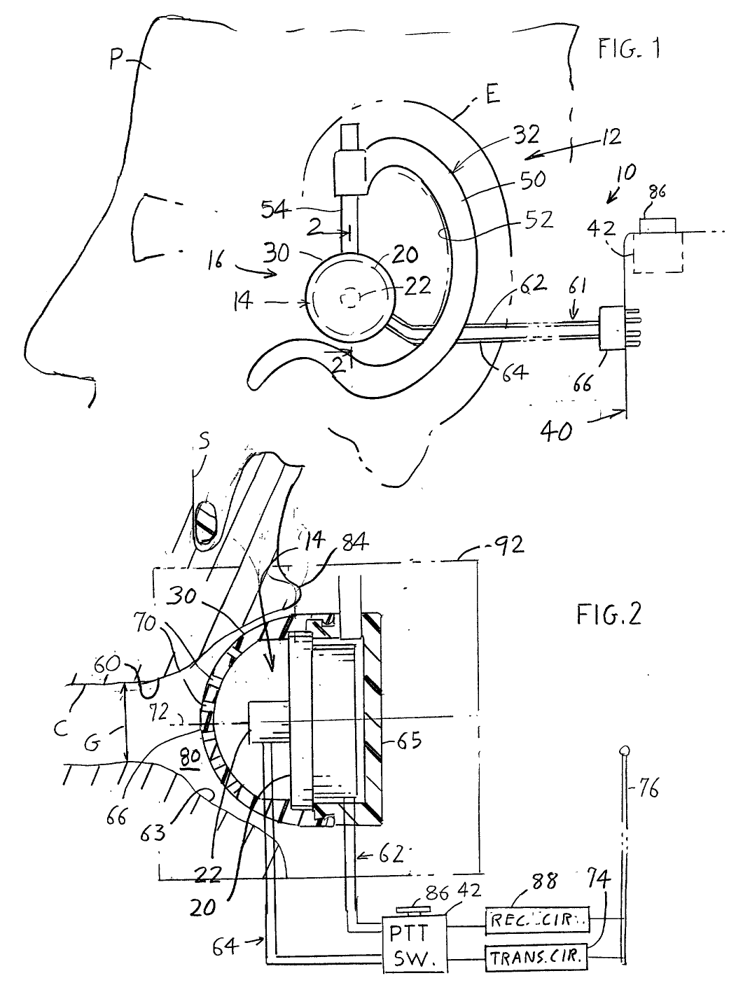

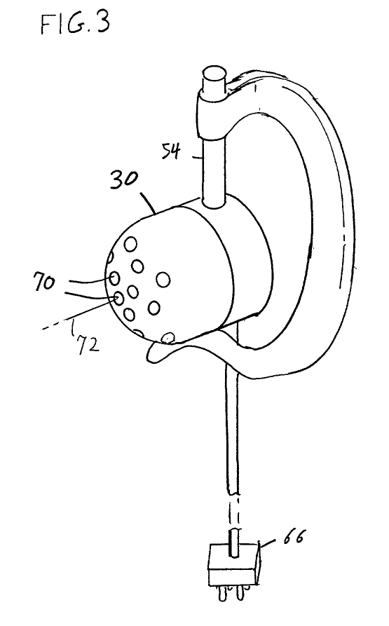

FIG. 2 shows that the ear canal C has a width G of about 0.3 inch at its outer end 60. The outer end lies at the inside of walls 63 that form an ear entrance region 80. The region tapers to a small diameter and merges with the ear canal outer end 60. At the outer end 60 of the ear canal, the diameter is about 0.35 inch for most people. The ear canal C is of a largely constant diameter of about 0.3 inch inside of the end 60. The shell has a distal side 65 facing away from the ear canal, and a front end or proximal side 66 that faces the ear canal. The proximal side has numerous holes 70 through which sound can pass, although it is possible to connect them to form a single slot or hole.

The speaker 20 is mounted in the shell so it faces the holes 70 to allow a high proportion of the sound generated by the speaker to reach the ear canal. It is noted that the shell has a larger diameter than the diameter G of about 0.35 inch of the outer portion of the ear canal, so the shell cannot fit into the ear canal. The shell diameter is preferably at least 0.4 inch and the shell is rigid, so it can not be inserted deep (over 1 cm) into the ear canal.

The microphone 22 lies in the shell, on a side of the speaker that is closest to the porous proximal end or side 66 of the shell. The microphone has a much smaller width, or radius, in a direction perpendicular to the axis 72 of the proximal end of the shell, so the microphone blocks only a small portion of the path of sound moving from the speaker 20 to the ear canal C. The microphone 22 preferably blocks less than half the area of the speaker 32 and more preferably less than one-fourth the area of the speaker 32.

The microphone 22 picks up sound generated by the person when the person speaks. Applicant is not certain as to how the sound which primarily emerges from the mouth of the person, is picked up by the microphone. However, tests of an apparatus of the type illustrated, have shown that the voice of the person is clearly picked up by the microphone so that it can be broadcast and clearly heard by other radios in the PTT system. Applicant believes that sound generated by the person, travels through the skull of the person and generates sound in the ear canal and immediately outside of it, with such sound passing through the porous proximal end 66 of the shell to the microphone. In any case, applicant's tests show that the sound clearly reaches the microphone.

FIG. 2 shows that the complete PTT system includes the conductors 62, 64 that respectively connect the speaker 20 and microphone 22 to the PTT switch 42. The switch is connected through a transmit circuit 74 to an antenna 76 to transmit sound from the microphone 22 to the antenna 60 for broadcast to all speakers in the PTT system. Of course, the electrical signals on line 64 representing the voice of the speaker, are used to modulate a radio carrier frequency signal, with the modulated RF signal transmitted by the antenna 60. So long as a button 86 on the PTT switch is depressed, signals are not transmitted through the line 62 to the speaker 20, so the speaker is silent. When the PTT switch button is not depressed, radio frequency signals received by the antenna pass through a receive circuit 88 that demodulates and amplifies them, and transmits the audio frequency signals to the speaker to energize it.

The speaker/mike assembly 14 is comfortable to wear because it is of light weight and hangs on the outer ear, and because it is not inserted into the ear canal. Devices that are inserted into the ear canal and that seal against the walls of the ear canal, create discomfort for some people, especially when such devices must be worn for many hours at a time. Applicant's shell 30 lies in the sound pickup region 80 immediately outside the ear canal, so sound from the speaker 20 can pass through the ear canal to be easily heard, and so that sound created by speaking of the person, that applicant has found to exist in the region 80, can be picked up by the microphone. However, the shell is not sealed to the inside walls of the ear canal, so the shell does not create discomfort there. Also, the shell preferably lies loosely (does not seal against sound) in the region 80 outside the ear canal, so there is no large pressure against that region of the person's ear to create discomfort there.

It should be noted that it common to provide a speaker in the region 80 outside the ear canal. It also should be noted that there are ear buds sold under the trademark JABBA that include a speaker facing and sealed to the ear canal and a microphone that lies away from a position directly in front of the canal, for use in cellular phones. In such prior art apparatus, the microphone lies outside the stream of sound passing between the speaker and ear canal to avoid having the microphone pick up sound from the speaker and create a feedback that must be squelched or that otherwise creates an irritating loud tone. In such a feedback loop, sound of a single pitch is emitted from the speaker at the highest amplitude that the speaker and its amplifier can produce. Of course, the microphone in prior art non-PTT systems may pick up very weak sound from the speaker (below −3 dB or −6 dB of sound an inch in front of the speaker) but this is too weak to commonly produce a feedback loop. In PTT systems, there is not a problem with feedback of sound from the speaker to the microphone, since the speaker is off whenever the microphone is turned on in a PTT system. As a result, applicant is able to place the microphone in the stream of sound that reaches the ear canal without danger of a sound feedback loop.

As shown in FIG. 2, the ear entrance region 80 leading to outer end 60 of the ear canal, is tapered in width, and the tapered proximal end 66 of the shell preferably lies in the entrance. The proximal end 66 of the shell is substantially spherically curved and convex on its outside, and lies within the entrance region 80 which leads to the ear canal. The entrance region extends from the ear canal entrance 60 and outward by about three-quarters inch to the most outward part 84 of ear cartilage that forms the tapered region leading to the ear canal. The axis 72 extends away from a side S of the head of the person. It would be possible to place the speaker 20 and microphone 22 anywhere within a sound-pickup region 92 and still have the microphone pick up sufficient sound to broadcast speech that could be heard by other transceivers in the group, although not as well as for a microphone 22 lying at least partially within the entrance region. The pickup region 92 is a largely cylindrical region with an axis on the axis 72 of the shell that extends into the entrance to the ear canal and that has a length along its axis of 1.5 inches and a radius of 0.75 inch. The microphone should lie in this pickup region.

It is possible to mount a microphone adjacent to or in the entrance region of the ear canal, with a speaker lying elsewhere such as at the other ear.

However, applicant does not know, at this time, of any advantage to such a system.

Thus the invention provides a PTT transceiver and a speaker/microphone assembly therefor, which enables the speaker and microphone to lie in a small shell that mounts at one ear and that effectively picks up sound to be transmitted by radio waves and to generate sound representing received radio waves. The microphone is mounted in a pickup region adjacent to the ear canal, and preferably at least partially in the entrance region of the ear canal. The microphone lies along the stream of sound passing from the speaker to the ear of the person. The speaker and microphone are preferably mounted in a shell with a proximal end having one or more holes, with the microphone, which is easily made of a smaller diameter than the speaker, lying in front of the speaker and with the front end of the shell lying loosely in the entrance region of the ear canal.

Although particular embodiments of the invention have been described and illustrated herein, it is recognized that modifications and variations may readily occur to those skilled in the art, and consequently, it is intended that the claims be interpreted to cover such modifications and equivalents.

What is claimed is

1. A PTT transceiver which includes a microphone, a speaker, a PTT switch which can be manually switched from a receive mode to a transmit mode, and transceiver circuitry which broadcast radio waves representing sound detected by said microphone only when said PTT switch is in said transmit mode and which detects radio waves representing sound and delivers signals representing the sound to the speaker only when the PTT switch is in said receive mode, including:
a mount assembly that mounts on a person's head and that holds said speaker outside but adjacent to one of the person's ear canals, and that holds said microphone outside but adjacent to the same ear canal and in the stream of sound that passes from the speaker to the person's ear canal.

2. The transceiver described in claim 1 wherein:
said mount assembly includes a bar with a concave side that fits around and faces the back of a person's ear, said bar having upper and lower bar ends, said mount assembly including a rod that extends primarily vertically from one of said bar ends, and a shell that is mounted on said rod to lie directly outside the person's ear canal when said bar concave side lies substantially against and around the back of the ear;
said shell has a proximal end for lying closest to the ear canal; said proximal end having at least one opening;
said speaker and microphone both lie in said shell.

3. The transceiver described in claim 1 wherein:
said mount assembly includes a shell with an opening, said speaker and microphone each mounted in said shell and facing said opening to pass out and receive in sound through said opening, said microphone and speaker each having a diameter and said microphone having a smaller diameter than said speaker and lying between said speaker and said at least one opening.

4. The transceiver described in claim 3 wherein the person's ear forms an ear entrance region extending about 0.75 inch outward from the outer end of the ear canal, and wherein:
said shell opening lies in said ear entrance region.

5. In a PTT transceiver that includes a speaker and that, when the transceiver is turned on it, remains on continuously except when a PTT switch is operated, the transceiver including a microphone that is on only while the PTT switch is being operated, the output of the microphone being amplified and transmitted to a remote station which has a remote speaker and remote microphone, the improvement comprising:
a mount assembly for holding said speaker and microphone at an ear of a person so a stream of sound can move from said speaker to the ear, with said microphone lying in said stream of sound so there would be a feedback loop if all speakers and microphones were on at the same time.

6. The transceiver described in claim 5 wherein:
said mount assembly includes a shell with a front portion having an opening therein, said microphone and speaker lying in said shell with said microphone being smaller than said speaker and lying in front of said speaker to lie closer to said front portion than does said speaker.

7. Apparatus for use by a person to pick up sound from the person when the person is speaking, comprising:
a microphone;
a mount which is mounted on the person and which holds said microphone immediately outside an ear of the person, in a sound pickup region that is of cylindrical shape with an axis and with a radius of 0.75 inch and with a length along said axis of 1.5 inches, said region extending along said axis from an outer end of the person's ear canal and in a direction away from a side of the head of the person where said ear canal outer end is located.

8. The apparatus described in claim 7 including:
a shell with proximal and distal ends and with at least one opening in said proximal end;
an electrically energizeable speaker with a front face from which sound from said speaker emerges when said speaker is electrically energized, said front face facing primarily said proximal end of said shell;
said microphone lying is said shell between said speaker front face and said shell proximal end.

9. The apparatus described in claim 8 wherein:
said shell proximal end lies in an ear entrance region that extends 0.75 inch from the outer end of the ear canal.

10. A method for generating sound representing received electrical signals from a remote location, to pass the sound to the ear of a person, and upon the giving of a command to transmit, picking up and transmitting to said remote location sound generated by the person during speaking and simultaneously terminating said generating of sound representing signals from the remote location, comprising:
placing a speaker that has a front, adjacent to the person's ear, and energizing said speaker to generate said sound representing received electrical signals when said command to transmit is not being given;
placing a microphone adjacent to the person's ear to detect sound thereat and transmitting signals representing said detected sound to said remote location during the giving of a command to transmit, where said microphone is positioned so it picks up sound from said speaker equal to at least −3 dB of the level of sound one inch in front of said speaker.

11. The method described in claim 10 wherein:
said step of placing a speaker and placing a microphone, includes placing both of them in a shell that has a proximal end with an opening, orienting said speaker and microphone so they can efficiently pass sound out of said shell through said opening and receive sound passing into said shell through said opening.
